(19) United States
(12) Patent Application Publication
(10) Pub. No.: US 2002/0021078 A1
(43) Pub. Date: Feb. 21, 2002

(54) Electron gun, method of manufacturing the same and cathode ray tube

(76) Inventors: Yoshio Fuwa, Aichi (JP); Keizo Mori, Aichi (JP); Masashi Sato, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/903,608

(22) Filed: Jul. 13, 2001

(30) Foreign Application Priority Data
Jul. 24, 2000 (JP) P2000-222648

(51) Int. Cl. H01J 29/50

(52) U.S. Cl. 313/417

(57) ABSTRACT

The present invention provides an electron gun which is excellent in voltage-resistant characteristics and has a first electrode less deformed, and a method of manufacturing the same.

An electron gun according to the present invention is such one that includes a first electrode and other electrodes, in which electrodes excluding the first electrode and a holder for fitting an electrode are supported by an insulating supporter member. A first electrode structure into which the first electrode and a cathode are integrated with each other is fitted to the holder. This allows a deformation of the first electrode due to beading to be avoided. Moreover, because whole electrodes supported by the insulating supporter member can be washed before fitting the first electrode structure, it is possible to make an electron gun have excellent voltage-resistant characteristics.

### BACKGROUND OF THE INVENTION

1. Field of the Invention

The present invention relates to an electron gun, a method of manufacturing the same, and a cathode ray tube.

2. Description of the Related Art

In general, an electron gun which is used in a cathode ray tube is constructed in such a manner that a first electrode and other plural electrodes are supported by insulating supporter members, i.e. a pair of bead glasses.

FIG. 1 shows an in-line type electron gun as an example of conventional electron guns.

This electron gun 1 has three cathodes K [Kr, Kg, Kb] which are arranged in line, and also has a first electrode G1, a second electrode G2, a third A electrode G3A and a third B electrode G3B, a fourth electrode G4, a fifth electrode G5, a sixth A electrode G6A, an intermediate electrode GM, and a sixth B electrode G6B. These electrodes are arranged along the same axis as that of the cathodes K.

A supporting pin 3 provided in each electrode is embedded into a pair of bead glasses 2A and 2B. In other words, there first electrode G1 through to sixth B electrode are supported by the pair of bead glasses 2A and 2B.

As shown in FIG. 2, the cathodes K [Kr, Kg, Kb ] are supported by a ceramic base 4 and arranged in line. The ceramic base 4 is fixed to the first electrode G1 through spacers 5. In this way, a so-called first electrode structure 6 is formed, into which the electrode and cathodes are integrated with each other.

An example of voltages applied to the respective electrodes is as follows: 0V is applied to the first electrode G1;

about 650V to the second electrode G2 and the fourth electrode G4; about 5.3 kV to the third A electrode G3A and the sixth A electrode G6A; about 5.7 kV to the third B electrode G3B and the fifth electrode G5; about 14 kV to the intermediate electrode GM; and about 27 kV of an anode potential to the sixth B electrode G6B.

A first quadrupole lens is formed between the third A electrode G3A and the third B electrode G3B. A second quadrupole lens is formed between the fifth electrode G5 and the sixth A electrode G6A. A main lens is formed between the sixth A electrode G6A and the sixth B electrode G6B. FIG. 3 is a flow chart showing a main process for manufacturing a conventional electron gun. First of all, the electrodes G2 through to G6B are washed in step S1. Next, cathodes K [Kr, Kg, Kb] are incorporated in the first electrode G1 to form a so-called first electrode structure 6 of FIG. 2 in step S2. Further, an outward appearance of the first electrode structure 6 is inspected in step S3.

Next, the first electrode structure 6 through to the sixth B electrode G6B are positioned through a jig to perform a so-called parts-assembling in step S4. Further, the electrodes G1 through to G6B are supported by bead glasses 2A and 2B in step S5 (beading step). Next, an electron gun is inspected in step S6. The electron gun is completed via the above steps.

All these steps S1 through to S6 are executed in a clean room.

As described above, the conventional electron gun is manufactured by washing the respective electrodes incorporating the cathodes K into the first electrode G1 to form the first electrode structure 6 and then supporting the respective electrodes including the first electrode structure 6 by the bead glasses members 2A and 2B. Accordingly, the entire electron gun is not washed after beading.

In order to improve voltage-resistant characteristics of the electron gun, a wash after beading is desired. However, if the electron gun is washed after beading, the cathodes K are also washed and affected in its characteristics. For this reason, the wash after beading could not be performed in the past.

Moreover, during the beading step in which the respective positioned electrodes are pressed against the bead glasses 2A, 2B for supporting them, especially to the first electrode G1 is applied a load from being pressed against the bead glasses 2A, 2B. As a result, the first electrode G1 may sometimes be deformed.

If the first electrode G is deformed, a positional shift occurs between beam apertures of the first electrode G1 and the cathodes K, or a distance d01 between the beam apertures of the first electrode G1 and the cathodes K fluctuates. Accordingly, if the first electrode G1 is deformed to a large extent, inconvenience will be caused during operation of a cathode ray tube Therefore, an electron gun whose first electrode G1 is largely deformed will be an inferior product.

### SUMMARY OF THE INVENTION

In view of the foregoing point, the present invention aims to provide an electron gun which is excellent in voltage-resistant characteristics and in which the first electrode is less deformed, and a method of manufacturing the electron gun.

The present invention also provides a cathode ray tube including such an electron gun.

An electron gun according to the present invention is such one as comprises a first electrode and other electrodes, in which the above other electrodes are supported by an insulating supporter member, a holder for fitting an electrode being supported by the insulating supporter member, the first electrode and a cathode being integrated with each other into a first electrode structure, and the first electrode structure being fitted to the holder.

An electron gun according to the present invention has a structure in which the first electrode structure is fitted to this holder supported by the insulating supporter member. Because the first electrode G1 is not directly supported by the insulating supporter member, a so-called beading load is not applied to the first electrode G1, so that the first electrode G1 can be prevented from being deformed.

Moreover, a electrode group structure before the first electrode structure is fitted, namely, the body of an electron gun except the first electrode structure can be washed in whole. By virtue of washing the electrode group structure in whole after beading, the voltage-resistant characteristics of electron gun can be improved.

A method of manufacturing an electron gun according to the present invention is a method for manufacturing such an electron gun as comprises a first electrode and other electrodes. It has an electrode supporting step of supporting the other electrodes and a holder for fitting an electrode by an insulating supporter member, and another step of fitting a first electrode structure into which the first electrode and cathodes are integrated with each other into the holder.

Moreover, it may comprise a step of fitting the first electrode structure to the holder after washing an electrode group structure supported by the insulating supporter member.

In the method of manufacturing an electron gun according to the present invention, because the first electrode structure is fitted to the holder after other electrodes except the first electrode G1 and the holder are beaded, the beading load is not applied to the first electrode, thus preventing the first electrode G1 from being deformed.

Furthermore, because the first electrode structure can be fitted after inspecting the electrode group structure, it will be possible to select beforehand the first electrode structure of good quality and fit it to the holder. This enables the rate of good product of the manufactured electron gun to be raised.

In addition, because the positional shift of beam apertures of the respective electrodes can be measured in a state of the electrode group structure before the first electrode structure is fitted, the edges of beam apertures will easily be recognized.

In the method of manufacturing an electron gun according to the present invention, the electrode group structure can be washed before fitting the first electrode structure. Therefore, such dirt as sticks after the electrodes are supported by the insulating supporter member, namely, so-called dirt which sticks after beading is cleanly eliminated.

A cathode ray tube according to the present invention is a cathode ray tube comprising such an electron gun as includes a first electrode and other electrodes. The electron gun has the construction in which the above other electrodes are supported by an insulating supporter member, a holder for fitting an electrode being supported by the insulating supporter member, the first electrode and a cathode being integrated with each other into a first electrode structure, and the first electrode structure being fitted to the holder.

Because the cathode ray tube according to the present invention is provided with the above-mentioned electron gun, the voltage-resistant characteristics is improved. Moreover, a less amount of deformation of the first electrode G1 in operation is caused, thus allowing the amount of deformation of the first electrode G1 to be stabilized.

According to the cathode ray tube of the present invention, because it is provided with the above electron gun, voltage-resistant characteristics can be improved. Moreover, the less amount of deformation of the first electrode G1 in operation is caused, so that the amount of deformation of the first electrode G1 is stabilized. This makes an initial drift of luminance and color stable. Therefore, a cathode ray tube of good quality can be provided.

### BRIEF DESCRIPTION OF DRAWINGS

FIG. 1 is a diagram showing an example of a conventional electron gun. This is a side view for explaining a layout of each electrode fixed by bead glasses;

FIG. 2 is a sectional diagram for explaining the structure of a conventional first electrode structure. This shows cathodes fixed at a ceramic base and a first electrode fitted opposite to these cathodes;

FIG. 3 is a flow chart showing a process for manufacturing a conventional electron gun;

FIG. 4 shows an embodiment of an electron gun according to the present invention. This is a side view for explaining a layout of each electrode fixed by base glasses;

FIG. 5 is a structure diagram in which the electron gun shown in FIG. 4 rotated by an angle of 90 degrees is seen, e.g. from the upper part of FIG. 4;

FIG. 6 shows a state before a first electrode structure is fitted, i.e. a structure of a electrode group structure in an electron gun according to the present invention;

FIG. 7 is an exploded perspective view of a holder and the first electrode structure according to the present invention;

FIG. 8 is a diagram for explaining the relation between the first electrode structure and the holder. This is a sectional view showing a state in which the first electrode structure is fitted to the holder;

FIG. 9 is a flow chart showing a process for manufacturing the electron gun according to the present invention; and

FIG. 10 is a structure diagram showing an embodiment of cathode ray tube according to the present invention.

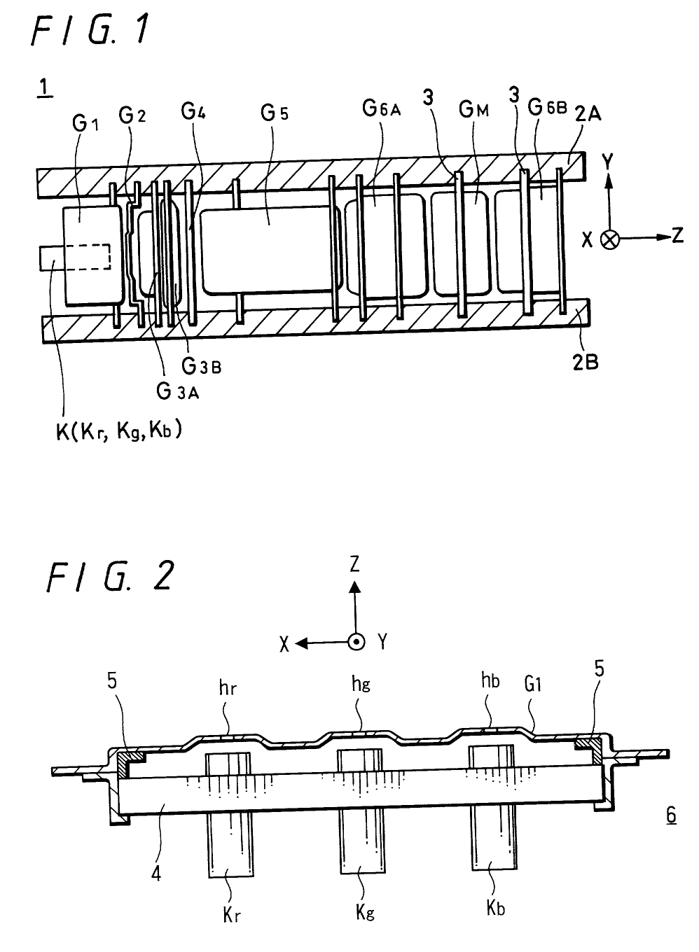

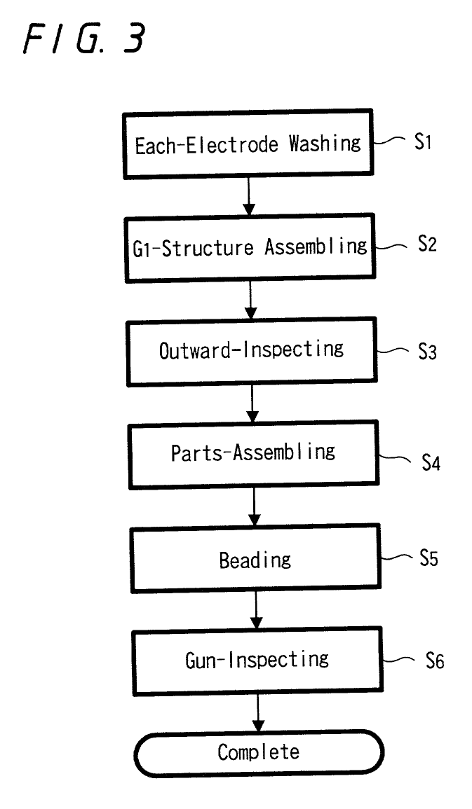

### DETAILED DESCRIPTION OF A PREFERRED EMBODIMENT

An embodiment of the present invention will be described below with reference to the drawings.

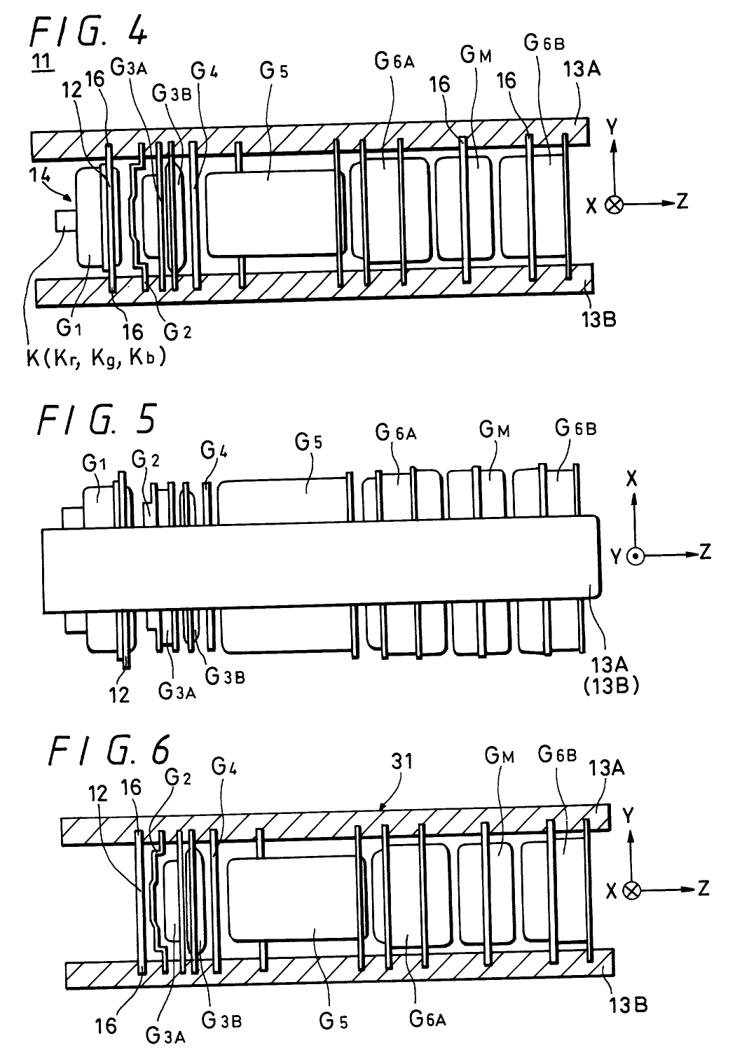

FIG. 4 and FIG. 5 show an embodiment of an electron gun according to the present invention.

FIG. 6 shows a state before fitting the first electrode structure, i.e. construction of the electrode group structure in the electron gun according to the present invention.

In an electron gun 11 according to this embodiment, as shown in FIG. 6, electrodes other than a first electrode G1 and a holder 12 are supported by an insulating supporter member, e.g. bead glasses 13 [13A and 13B].

The electron gun 11 according to this embodiment is constructed, as shown in FIG. 4 and FIG. 5, in such a manner that a so-called first electrode structure 14 having cathodes K incorporated in the first electrode G1 is fitted to the holder 12.

This embodiment is such a case that the present invention is applied to the in-line type electron gun as in the above case. The present invention is not limited to such in-line type electron gun.

In this embodiment, the holder 12, a second electrode G2, a third A electrode G3A, a third B electrode G3B, a fourth electrode G4, a fifth electrode G5, a sixth A electrode G6A, an intermediate electrode GM, and a sixth B electrode G6B are aligned along the same axis.

These electrodes G2 through to G6B and holder 12 have each supporting pin 16 integrated therewith. The supporting pin 16 is embedded in the bead glasses 13A and 13B. In other words, each of these electrodes G2 through to G6B and holder 12 is supported by the bead glasses 13A and 13B. A first electrode structure 14 is fitted to the holder 12 by welding or the like.

An example of voltages applied to the respective electrodes is as follows: 0V is applied to the first electrode G1; about 650V to the second electrode G2 and the fourth electrode G4; about 5.3 kV to the third A electrode G3A and the sixth A electrode G6A; about 5.7 kV to the third B electrode G3B and the fifth electrode G5; about 14 kV to the intermediate electrode GM; about 27 kV of an anode potential to the sixth B electrode G6B.

A first quadrupole lens is formed between the third A electrode G3A and the third B electrode G3B. A second quadrupole lens is formed between the fifth electrode G5 and the sixth A electrode G6A. A main lens is formed between the sixth A electrode G6A and the sixth B electrode G6B.

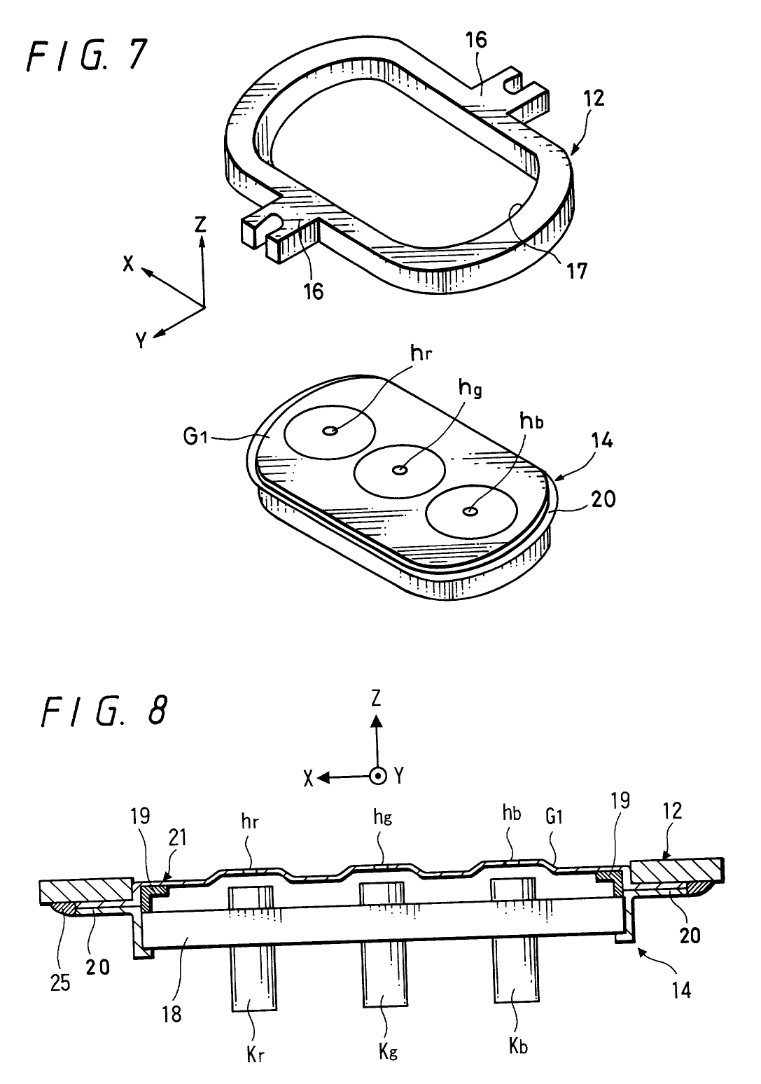

As shown in FIG. 7, the holder 12 is like a ring in shape and has an opening 17 of a size into which an end surface of the first electrode G1 on the side of the second electrode can be inserted. The holder 12 is formed so that a pair of supporting pins 16 to be embedded in the bead glasses 13A, 13B may be integrated therewith.

As shown in FIG. 8 in this embodiment, the first electrode structure 14 has three cathodes K [Kr, Kg, Kb] and the first electrode G1. The cathodes K [Kr, Kg, Kb] are supported by a ceramic base 18 and arranged in line. The cathodes K [Kr, Kg, Kb] are inserted into the first electrode G1 together with the ceramic base 18 and fixed thereto through spacers 19.

The first electrode G1 has a flange portion 20 and an end surface in which three beam apertures hr, hg, hb are formed corresponding to the cathodes Kr, Kg, Kb. The end surface portion 21 is formed in such a size that it can be inserted into the opening 17 in the holder 12. The flange portion 20 is formed in such a size that it will abut against the holder 12.

The end surface portion 21 of the first electrode structure 14 is inserted into the opening 17 in the holder 12 supported by the bead glasses 13A, 13B. The first electrode structure 14 is fixed to the holder 12, e.g. by the multipoint laser welding in a state that the flange portion 20 abuts against an end face of the holder 12. In FIG. 8, connecting portion 25 is the laser-welded portion.

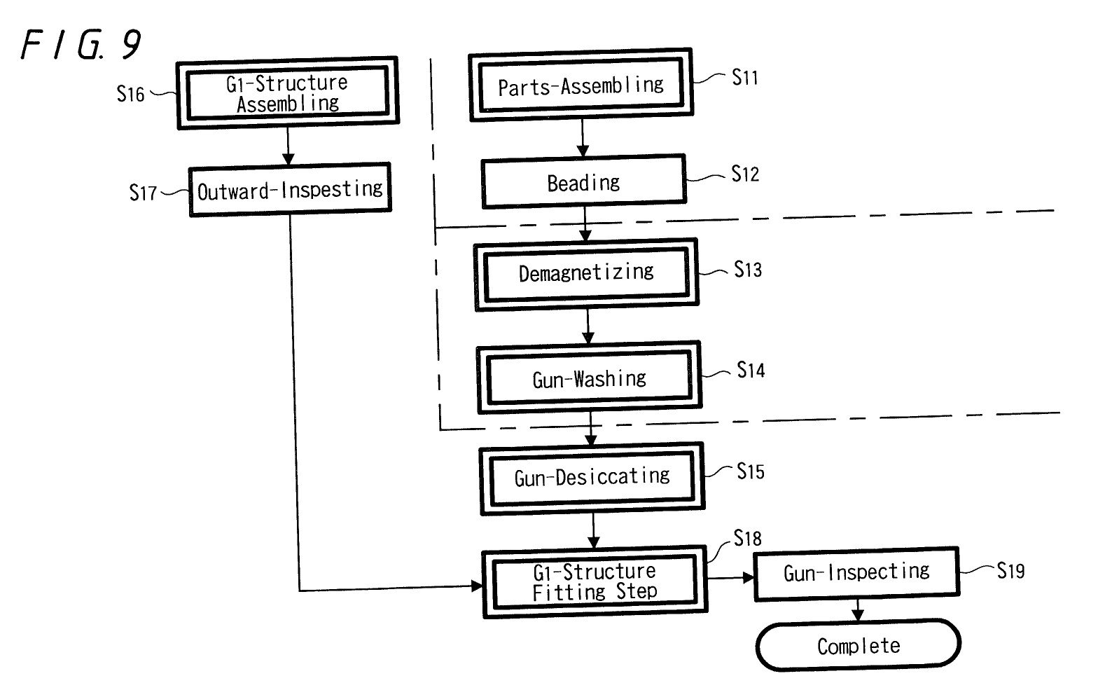

Next, a method of manufacturing the electron gun 11 will be described with reference to a flow chart of FIG. 9. FIG. 9 shows a main process for manufacturing the electron gun according to the present invention.

First of all, in parts-assembling step S11, the other electrodes excluding the first electrode G1, i.e. the second electrode G2 through to the sixth B electrode G6B and the holder 12 are positioned by a jig.

Next, in beading step S12, the second electrode G2 through to the sixth B electrode G6B and the holder 12 are supported by the bead glasses 13A, 13B.

Next, after drawing off the positioning jig, if necessary, each beaded electrode is subjected to a processing of demagnetization in demagnetizing step S13. This demagnetization processing is carried out, for example, when magnetized metal powder, etc. sticks to any electrode, for the purpose of facilitating to remove the metal powder, etc. in the next washing step.

Next, in gun-washing step S14, the electrodes G2 through to G6B and the holder which are supported by the bead glasses 13A and 13B, i,e, the electrode group structure 31 shown in FIG. 6 is washed. This wash processing can be performed, e.g. by pure-warm-water ultrasonic washing.

Next, in gun-desiccating step S15, the washed electrode group structure 31 is desiccated. The desiccation maybe, e.g. heat desiccation.

On the other hand, in first-electrode-structure assembling step S16, the cathodes K[Kr, Kg, Kb] are incorporated in the first electrode G1 to prepare the first electrode structure 14. In the next outward-inspecting step S17, an outward appearance of the first electrode structure 14 is inspected.

In first-electrode-structure fitting step S18, the first electrode structure 14 is fitted to the holder 12 of the electrode group structure 31, for example, by multipoint laser welding. In other words, the first electrode structure 14 is inserted into the opening 17 of the holder 12 through its end surface portion 21. The first electrode structure 14 and the holder 12 are laser-welded together in a store that the flange portion 20 is pressed against the end face od the holder 12.

The positional determination when assembling and welding is performed as follows. For example, the X and Y directions are determined using an index pin. The Z direction is determined by pressing the flange portion 20 against the holder 12. Then, after a wire-connecting step, not shown, characteristics, etc. of the electron gun are inspected in gun-inspecting step S19.

After the above steps has been passed through, the electron gun 11 is completed.

In the above process, for example, the parts-assembling step S11, the beading step S12, and the not-shown step of drawing positioning jig can be performed under an environment outside a clean room, i.e. under an ordinary environment. The other steps of the first-electrode-structure assembling step S16, the outward-inspecting step S17, the demagnetizing step S16 through to the gun-inspecting step S19 can be performed inside the clean room.

Alternatively, for example, the parts-assembling step S11 through to the gun-desiccating step S15 may be performed under an environment outside the clean room. The other steps of the first-electrode-structure assembling step S16, the first-electrode-structure fitting step S18, the outward-inspecting step S17, and the gun-inspecting step may by performed inside the clean room.

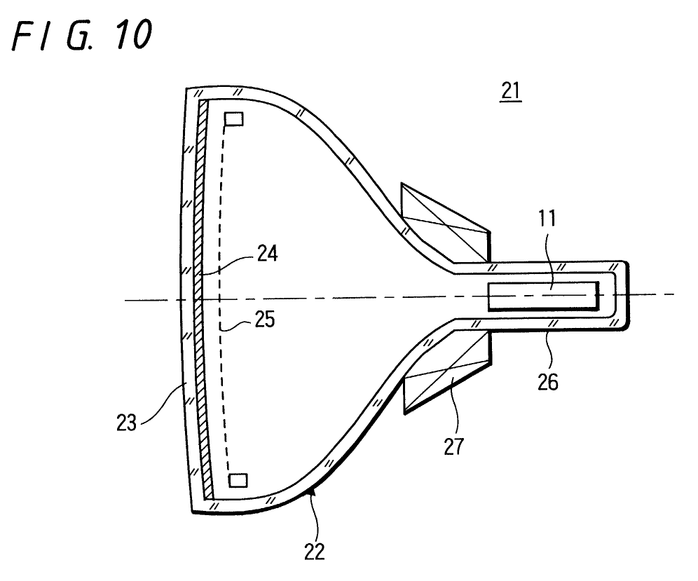

FIG. 10 shows an embodiment of cathode ray tube according to the present invention. The cathode ray tube 21 according to the present embodiment has a color fluorescent screen 24 formed on the inner surface of a panel 23 of the body 22 of cathode ray tube. A color selection mechanism 25 is disposed opposite to the color fluorescent screen 24. The above described electron gun 11 is disposed inside a neck portion 26. A deflection yoke 27 is fitted to a funnel portion of the cathode ray tube 21.

According to the cathode ray tube 21 according to this embodiment, by comprising the electron gun 11 in which the first electrode structure 14 is fitted to the holder supported by the bead glasses 13A, 13B, its voltage resistant characteristics can be improved.

Moreover, the amount of deformation of the first electrode G1 in operation can be reduced, so that the amount of deformation of the first electrode G1 is stabilized and initial drifts of luminance and chromaticity can be stable in turn. Thus, the quality of cathode ray tube can be improved.

In the above embodiments, although the present invention is applied to the in-line type electron gun and the cathode ray tube comprising the same, the present invention is of course applicable to the other electron guns of various electrode structures and the cathode ray tube comprising these electron guns.

What is claimed is:

1. An electron gun comprising a first electrode and other electrodes, wherein
said other electrodes are supported by an insulating supporter member,
a holder for fitting an electrode being supported by said insulating supporter member,
said first electrode and a cathode being integrated with each other into a first electrode structure, and
said first electrode structure being fitted to said holder.

2. A method of manufacturing an electron gun including a first electrode and other electrodes, comprising the steps of
an electrode supporting step of supporting said other electrodes and a holder for fitting an electrode by an insulating supporter member, and
another step of fitting a first electrode structure into which said first electrode and a cathode are integrated with each other to said holder.

3. A method of manufacturing an electron gun according to claim 2, wherein
after an electrode group structure supported by said insulating supporter member is washed, said first electrode structure is fitted to said holder.

4. A cathode ray tube provided with an electron gun including a first electrode and other electrodes, wherein
said other electrodes are supported by an insulating supporter member,
a holder for fitting an electrode being supported by said insulating supporter member,
said first electrode and a cathode being integrated with each other into a first electrode structure, and
said first electrode structure being fitted to said holder.
